(19) United States
(12) Patent Application Publication
(10) Pub. No.: US 2007/0106743 A1
(43) Pub. Date: May 10, 2007

(54) Sharing disc changers among multiple user devices

(76) Inventors: Kenneth F. Nicholson, San Ramon, CA (US); Timothy Cutting, Los Gatos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/588,570

(22) Filed: Oct. 26, 2006

Related U.S. Application Data
(60) Provisional application No. 60/730,725, filed on Oct. 26, 2005.

(51) Int. Cl. G06F 15/167

(52) U.S. Cl. 709/213

(57) ABSTRACT

In one embodiment, a system includes at least one disc changer to store media content, and multiple user devices coupled to the disc changer. At least a portion of the media content has copyright protection. The multiple user devices share the media content of the disc changer without violating the copyright protection of the media content.

### RELATED APPLICATIONS

The present application claims priority to U.S. Provisional Applications Ser. No. 60/730,725, filed on Oct. 26, 2005, which is incorporated herein in its entirety.

### FIELD OF THE INVENTION

This invention relates generally to consumer electronic devices, and more particularly to sharing disc changers among multiple consumer electronic devices.

### BACKGROUND OF THE INVENTION

Media Center Edition (MCE) is a software program that runs on the Microsoft® Windows® XP operating system. The MCE program, combined with a personal computer (PC) that incorporates certain specified hardware, operates as a consumer electronic device that allows the user to record television programs, listen to music, watch DVDs, view photos, and more. Such a consumer electronic device is known as a media center.

A media center may have an external DVD changer connected to its IEEE 1394 port. A list of media content (e.g., DVD movies) available in the DVD changer can be presented to the user in a user interface provided by MCE. The pictorial representation of the media content is referred to as “cover art.” The user may select any DVD in the changer for playback by choosing the corresponding cover art. Multiple DVD changers can be connected (daisy-chained) together via 1394 cables to allow a large library of DVDs to be available for viewing upon demand.

A house may have multiple media centers connected via a home network (e.g., local area network). Some of the media centers may have attached DVD changers. However, current mechanisms do not allow users to share DVD changers across the network. FIG. 1 illustrates prior art user interfaces (IUIs) provided on media centers having attached DVD changers. In particular, media center A senses the presence of a local DVD changer A connected via the IEEE 1394 interface and requests the identity of the discs contained in the DVD changer A. Based on the identity of the discs received from the local DVD changer A, the media center A displays a UI 100 containing images representing DVD content on each disc in the DVD changer A. Similarly, a UI 102 provided by media center B displays images representing DVD content on each disc in DVD changer B. Hence, the user of media center A cannot view cover art available on DVD changer B, and vice versa.

Some prior art solutions address the problem of sharing media content over a network by copying DVD data to a hard drive and allowing media centers to access the hard drive via a network. However, for copyrighted DVDs, such actions can be considered a violation of the rights of the copyright owner.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates user interfaces provided by media center PCs in accordance with a prior art embodiment.

FIG. 2 is a block diagram of one embodiment of a system facilitating the sharing of disc changers among multiple user devices.

FIG. 3 illustrates an exemplary user interface provided by media center PCs in accordance with one embodiment of the invention.

FIGS. 4 and 5 are flow diagrams of one embodiment of a method for facilitating the sharing of disc changers among multiple user devices.

FIG. 6 is a flow diagram of one embodiment of a method for sharing DVD changers among multiple media center PCs.

FIG. 7 is a block diagram of one embodiment of a system for virtualizing a disc changer for client devices.

FIG. 8 is a flow diagram of one embodiment of a method for virtualizing a DVD changer for media center PCs.

FIG. 9 is a block diagram of an exemplary computer system that may be used to perform one or more of the operations described herein.

### DETAILED DESCRIPTION OF THE INVENTION

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disc including floppy discs, optical discs, CD-ROMs, and magnetic-optical discs, read-only memories (ROMs), random access memories (RAMs), EPROMs, EEPROMs, magnetic or optical cards, or any type of media suitable for storing electronic instructions, and each coupled to a computer system bus.

The invention also relates to media content used for performing the operations herein. Such media content may be stored in a storage medium, such as, but is not limited to, any type of disc including floppy discs, optical discs, CD-ROMs, and magnetic-optical discs, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes a machine readable storage medium (e.g., read only memory (“ROM”), random access memory (“RAM”), magnetic disc storage media, optical storage media, flash memory devices, etc.), a machine readable transmission medium (electrical, optical, acoustical or other form of propagated signals (e.g., carrier waves, infrared signals, digital signals, etc.)), etc.

Embodiments of the present invention relate to various aspects of sharing disc changer content among different user devices.

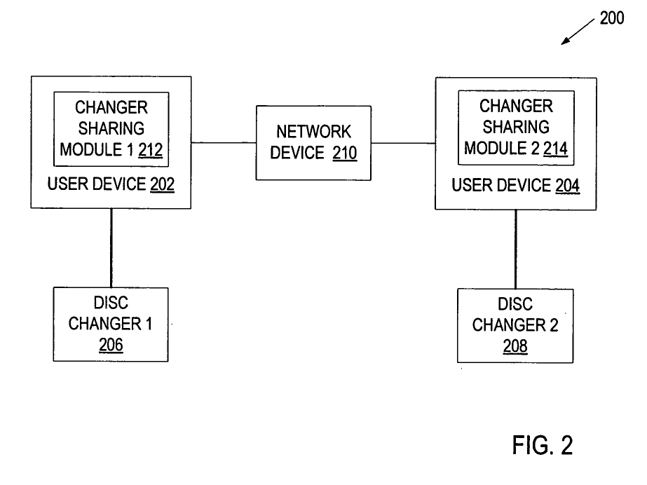

FIG. 2 is a block diagram of one embodiment of a system 200 facilitating the sharing of disc changers among multiple user devices. The system 200 includes user devices 202 and 204. The user devices 202 and 204 may be consumer electronic devices presenting media content to users. Such consumer electronic devices may include, for example, media center PCs, video game devices, audio devices (e.g., CD players and mini-disc players), etc.

The user devices 202 and 204 are coupled to a local network via a network device 210. In addition, the user devices 202 and 204 may be coupled to a wide area network (e.g., Internet). The local network may be a wireless or wired home network such as a local area network (LAN), Ethernet, Intranet, etc. The network device 210 may be a router, hub, switch or any other device providing network connectivity for the user devices 210.

Disc changers 206 and 208 are physically attached to user devices 202 and 204 respectively. Each disc changer 206 or 208 may be a SCSI device connected to the corresponding user device via an IEEE 1394 interface. The disc changers 206 and 208 include multiple discs. In addition, each disc changer 206 or 208 may be successfully connected (daisy chained) with other disc changers to allow a library of thousands of discs to be available for selection. Selected discs are loaded into disc changer drives. Each disc changer may have a single drive or multiple drives to allow different discs to be accessed simultaneously. The disc changers 206 and 208 store discs with various media content such as DVD content, HD DVD content, Blu-ray Disc content, digital photograph content (e.g., jpeg or jpg content), digital television recording content, video content (e.g., mpg, avi, rm, mov or mp2 content), digital audio content (e.g., mp3, aac or wma content), etc. Some or all of the discs stored on the disc changers 206 and 208 have copyright protection to prevent copying of the discs' contents.

Each user device 202 and 204 hosts a changer sharing module (modules 212 and 214 respectively). The changer sharing modules 212 and 214 allow the user devices 202 and 204 to share media content of both disc changers 206 and 208, while maintaining the original copyright protection of the media content. For example, if the user device 202 is a media PC in the bedroom and the user device is a media PC in the home theater room, the changer sharing modules 212 and 214 allow a user located in the bedroom to selectively view any DVD content from the DVD changer in the home theater room. Similarly, a user located in the home theater can selectively view any DVD content from the DVD changer located in the bedroom.

Each changer sharing module 212 and 214 provides a client-based functionality and a server-based functionality. The client-based functionality includes requesting data stored on the remote disc changer. The server-based functionality includes obtaining data from the local disc changer and providing this data to the requestor.

In one embodiment, the changer sharing modules 212 and 214 enable communication between the user devices 202 and 204 using the iSCSI protocol that allows a machine to use an iSCSI initiator to connect to a remote target. For example, when the user device 202 requests data from the remote disc changer 208, the changer sharing module 212 intercepts this request, encapsulates it into an iSCSI command, and transmits it to the target user device 204. The changer sharing module 214 on the target user device 204 intercepts the iSCSI command, translates it into a corresponding SCSI command and sends it to the local disc changer 208. The local disc changer 208 may respond, for example, by providing requested data or loading a specified disc into a disc drive. Accordingly, each user device perceives all remote disc changers as being locally attached, and therefore can utilize their contents without violating the original copyright protection of the discs.

In one embodiment, the changer sharing modules 212 and 214 allow each user device 202 and 204 to present a list of discs available on both disc changers 206 and 208. In particular, as will be discussed in more detail below, the changer sharing module 212 may obtain data identifying discs available on the remote disc changer 208, combine it with data identifying discs available on the local disc changer 206, and generate a combined list identifying media content available on both disc changers. For example, if user devices 202 and 204 are media center PCs, the changer sharing module 212 may provide combined data identifying discs available on both DVD changers 206 and 208 to the Window® Media Center Edition (MCE) program running on the media center PC 202, which will use the combined data to display a pictorial representation (“cover art”) of the DVD movies available in both DVD changers 206 and 208.

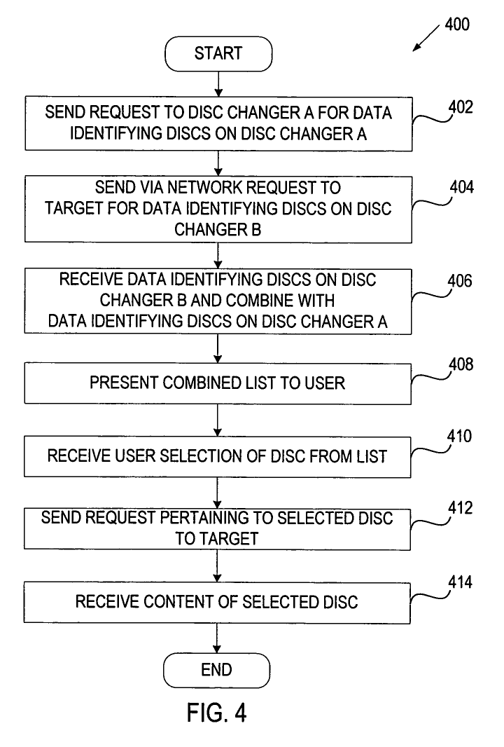

FIG. 3 illustrates an exemplary user interface (UI) 300 that can be provided by the media center PC 202 or 204 in accordance with one embodiment of the invention. The UI 300 includes cover art 302 representing available DVDs in the DVD changer 206 and cover art 304 representing available DVDs in the DVD changer 208. The UI 300 allows the user to select a DVD from the combined set of DVDs available on either changer.

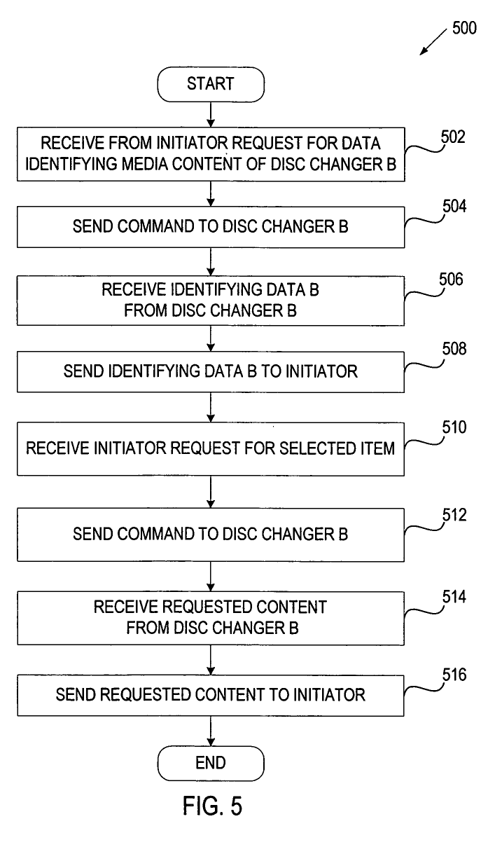

FIGS. 4 and 5 are flow diagrams of one embodiment of a method for facilitating the sharing of disc changers among multiple user devices. The method may be performed by processing logic that may comprise hardware (e.g., circuitry, dedicated logic, etc.), software (such as run on a general purpose computer system or a dedicated machine), or a combination of both. In one embodiment, processing logic resides in a changer sharing module 212 or 214 of FIG. 2.

Referring to FIG. 4, method 400 provides client-based functionality for facilitating the sharing of disc changers among multiple user devices. At block 402, processing logic sends a request to a local disk changer A for data identifying discs available on a local disc changer. Some or all of the discs on the disk changer A have copyright protection to prevent copying of their content to a hard drive or some other storage device. The data identifying discs available on the disc changer A may include identifiers of the discs and changer slots holding the discs. In one embodiment, the request is sent in the form of a SCSI command.

At block 404, processing logic sends a request to a target user device via the network for data identifying discs available on a disc changer B attached to the target user device. Some or all of the discs on the disk changer B have copyright protection. The data identifying discs available on the disc changer B may include identifiers of the discs and changer slots holding the discs. In one embodiment, the request is sent in the form of an iSCSI command from an initiator to a target.

At block 406, processing logic receives the data identifying discs available on the disc changer B from the target user device and combines this data with the data identifying discs available on the local disc changer A. Processing logic then uses the combined data to create a list of discs available on both disc changers A and B, and presents the list to the user (block 408). In an alternative embodiment, processing logic provides the combined data to a different module, which then uses this data to create the list, and then presents the created list to the user.

At block 410, processing logic identifies a disc selected by the user from the list. In one embodiment, processing logic identifies the selected disc by intercepting a SCSI command sent by the initiating user device. The SCSI command identifies the selected disc.

Next, processing logic determines whether the selected disc is stored on the local disc changer A. If so, processing logic forwards the SCSI command to the local disc changer A.

If processing logic determines that the selected disc is stored on the remote disc changer B, processing logic sends a request pertaining to the selected disc to the target user device (block 412). In one embodiment, the request is in the form of an iSCSI command encapsulating the original SCSI command.

At block 414, processing logic receives media content of the selected disc from the target user device and causes the media content to be presented to the user (e.g., played back on the display).

FIG. 5 is a flow diagram of one embodiment of a method 500 that provides server-based functionality for facilitating the sharing of disc changers among multiple user devices. At block 502, processing logic receives a request for data identifying discs available on a disc changer B from an initiating user device. In one embodiment, the request is in the form of an iSCSI command.

At block 504, processing logic translates the request of the initiating user device into a SCSI command and sends it to the disc changer B. At block 506, processing logic receives a SCSI message with data identifying discs available on the disc changer B from the attached disc changer B.

At block 508, processing logic sends the data identifying discs available on the disc changer B to the initiating user device. In one embodiment, the data is sent as part of an iSCSI message.

At block 510, processing logic receives a request pertaining to a disc selected by the user from the initiating user device (block 412). In one embodiment, the request is in the form of an iSCSI command identifying the selected disc and the slot holding the selected disc.

At block 512, processing logic translates the request into a SCSI command and sends it to its local disc changer B. Afterwards, processing logic receives the media content of the selected disc from the disc changer B (block 514) and sends this media content to the initiating user device using the iSCSI protocol (block 516).

In one embodiment, the initiating and target user devices are media center PCs that integrate the recording, storage and playback of digital media types including digital photographs (jpeg or jpg files), digital television recordings, video files (mpg, avi, rm, mov, mp2 files), digital music files (mp3, aac, wma files), radio stations, DVDs, etc. The media center PCs may include hardware to support decoding of television signals, design features to reduce heat and noise, high-fidelity sound capabilities, high-performance video and graphics capabilities and a remote control. In addition, media center PCs have device drivers to discover and control various media devices.

A DVD changer may be connected to a media center PC via an IEEE 1394 cable. A media center PC is able to sense the presence of a local DVD changer connected via the IEEE 1394 interface. For example, as part of the plug and play architecture of the Windows® operating system, the 1394 device driver may query the identity of all connected devices. Borrowing from the SCSI protocol, the IEEE 1394 interface may use the SBP2 protocol to implement SCSI over the 1394 bus. Any 1394 device discovered may then be matched with the appropriate driver. A driver may be a class driver designed to work with all devices of its class. The class driver is dependent on a mini-class driver that deals with the hardware-specific nature of a particular device.

In one embodiment, when the 1394 bus scan encounters a DVD changer, it views the DVD changer as two separate devices. The first device is the DVD drive within the DVD changer. This device is treated as a SCSI optical drive connected via the 1394 interface. An appropriate mini-class driver is loaded that corresponds to the device. The second device that the 1394 bus scan finds is a media changer device. The media changer device represents the firmware, electronics and mechanical elements that can switch the currently loaded disc to another one within the changer, eject the disc or load it into the DVD drive. The mini-class driver loaded for the changer is controlled by the media changer class driver. The mini-class driver communicates with the changer using the SCSI protocol. Embodiments of the invention virtualize the 1394 interface over a local network and redirect SCSI communication over the network using the iSCSI protocol.

By way of example, each media center PC may have a device driver named “mchanger.sys.” This device driver may be loaded regardless of whether the media center PC has a DVD changer attached. The device driver scans the 1394 bus to enumerate local DVD changers. If a local DVD changer is found, the device driver begins listening for requests on a predefined port address according to an iSCSI target implementation. The iSCSI target shares and arbitrates access to the local changer or changers.

Next, the mchanger.sys driver establishes its own iSCSI initiator session (client) and attempts to locate iSCSI targets on the local subnet. Various schemes can be used for locating iSCSI servers (e.g., iSNS or Rhapsody) without loss of generality. The driver then enumerates the available remote DVD changers and presents them to the application layer.

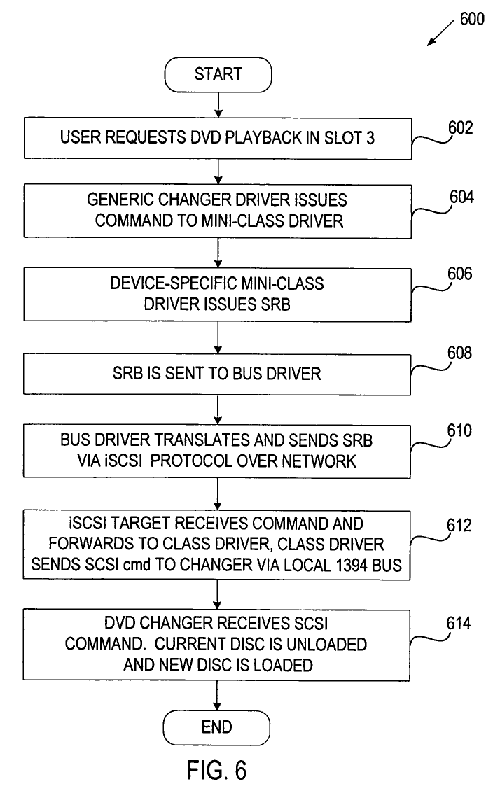

FIG. 6 is a flow diagram of one embodiment of a method 600 for remotely switching DVDs within a DVD changer. At block 602, a user requests a playback of a specified DVD (e.g., a DVD in slot 3). In response, a DVD player application sends a command to load the disc from the slot, and an I/O control message for the DVD changer is sent to the SCSI subsystem.

A generic DVD changer driver receives the message and issues a command to a device specific mini-class driver (block 604). The mini-class driver issues a SCSI request block (SRB) command (block 606) and sends it to the bus driver (block 608).

At block 610, the bus driver encapsulates SRB into an iSCSI command and sends it to the target device via the network. At block 612, the target receives the iSCSI command and forwards it to the class driver. The class driver translates the iSCSI command into a SCSI command and sends the SCSI command to the DVD changer via the local 1394 bus. At block 614, the DVD changer receives the SCSI command, and responds to it by unloading the current disc and loading the new disc into the disc drive.

Embodiments discussed above refer to an architecture in which multiple user devices can share disc changers attached to two or more user devices. Alternatively, a disc changer(s) may be attached to a single device that virtualizes this local disc changer(s) and presents the disc changer as a local resource to each user device. This single device may represent a server, and the multiple user devices may represent clients. The server may also act as a client when utilizing the content stored on the disc changer.

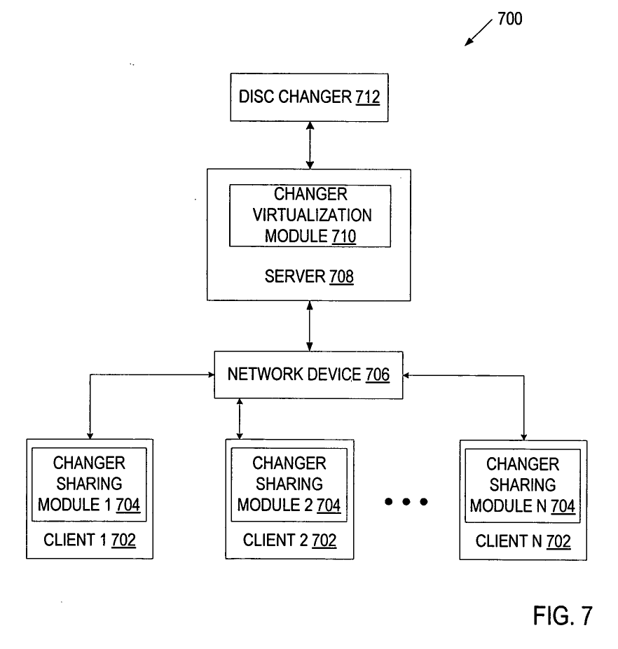

FIG. 7 is a block diagram of one embodiment of a system 700 for virtualizing a disc changer for client devices. The system 700 includes a server 708 that has one or more local disc changers 712 attached to the server 708 via the IEEE 1394 interface. Some or all of the discs stored on the disc changer 712 have a copyright protection to prevent copying of their contents to a hard drive or some other storage device.

The server 708 is coupled with client devices 702 via a local network that includes a network device 706. The network device 706 may be a hub, router or switch enabling connectivity of the clients 702 to the local network. In addition, the network device 706 may enable connectivity of the clients 702 to a wide area network (e.g., Internet). The local network may be a wired or wireless network such as LAN, Ethernet, Intranet, etc. The local network may connect devices in a residential house, a dormitory, or some other building. The clients 702 may be consumer electronic devices such as media center PCs, video game devices, audio devices, etc.

The server 708 hosts a changer virtualization module 710 that cooperates with changer sharing modules 704 of the clients 702 to virtualize the disc changer 712 and present the disc changer 712 as a local resource to the clients 702, thus maintaining the original copyright protection of the disks within the disc changer 712. The server 708 may also act as a client when utilizing content of the disc changer 712 and may include a changer sharing module 704 (not shown) to facilitate client-based functionality of the server 708.

The changer sharing modules 704 provide client-based functionality similar to that discussed above with respect to FIGS. 2, 4 and 6; and the changer virtualization module 710 provides server-based functionality similar to that discussed above with respect to FIGS. 2, 5 and 6. By way of example, the changer sharing modules 704 may reside on media center PCs 702 located in the living room, bedroom and den to allow users to remotely view DVD movies available on the DVD changer 712 from the different rooms in the house. The DVD changer 712, as well as the media server 708 to which the DVD changer is attached, may be located in the home theater room. As discussed above, the media server 708 may also act as a client, allowing a user to view DVD movies available on the DVD changer 712 from the home theater room.

In one embodiment, the changer virtualization module 710, in cooperation with the changer sharing modules 704, provide an extra layer that adds enhanced functionality on top of the Windows OS and MCE. In one embodiment, the enhanced functionality relies on third party DVD player software that includes a decryption module for decrypting DVD content (e.g., a decryption module for a content scramble system (CSS)).

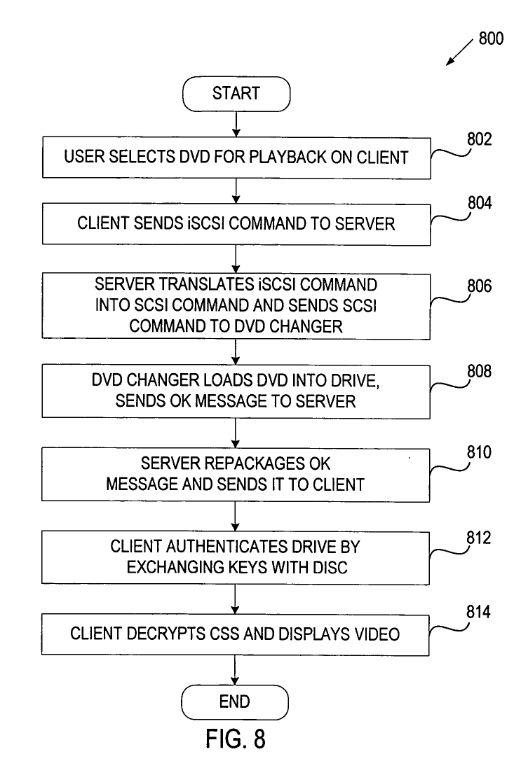

FIG. 8 is a flow diagram of one embodiment of a method 800 for virtualizing a DVD changer for media center PCs. The method may be performed by processing logic that may comprise hardware (e.g., circuitry, dedicated logic, etc.), software (such as run on a general purpose computer system or a dedicated machine), or a combination of both. In one embodiment, processing logic resides in a changer sharing module 702 and changer virtualization module 710 of FIG. 7.

Referring to FIG. 8, method 400 begins with the user selecting a DVD for a playback on a client device (block 802). As discussed above, the client device issues a SCSI command (e.g., SRB) identifying the selected DVD.

At block 804, processing logic at the client encapsulated the SCSI command into an iSCSI command and sends it to the media server. At block 806, processing logic at the media server translates the iSCSI command into a SCSI command and sends it to its DVD changer, which then loads the selected DVD into the disk drive and sends an OK message to the media server (block 808).

At block 810, processing logic at the media server, which operates as a proxy for the client, repackages the OK message and sends it to the client. By operating as a proxy, the media server allows the client to perceive the DVD changer as a local resource.

At block 812, the DVD player software at the client authenticates the drive by exchanging keys with the DVD. At block 814, the DVD player software at the client decrypts the CSS and displays the DVD content.

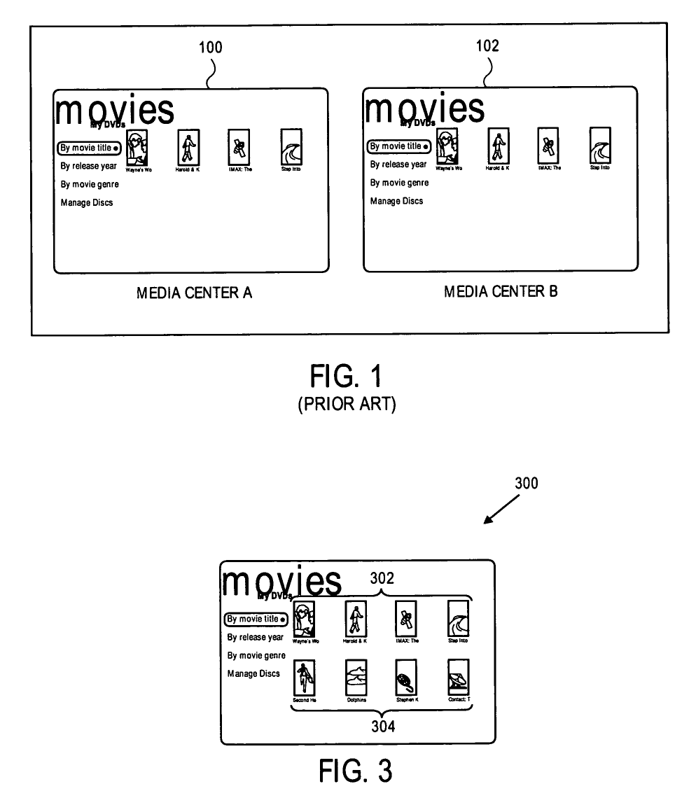

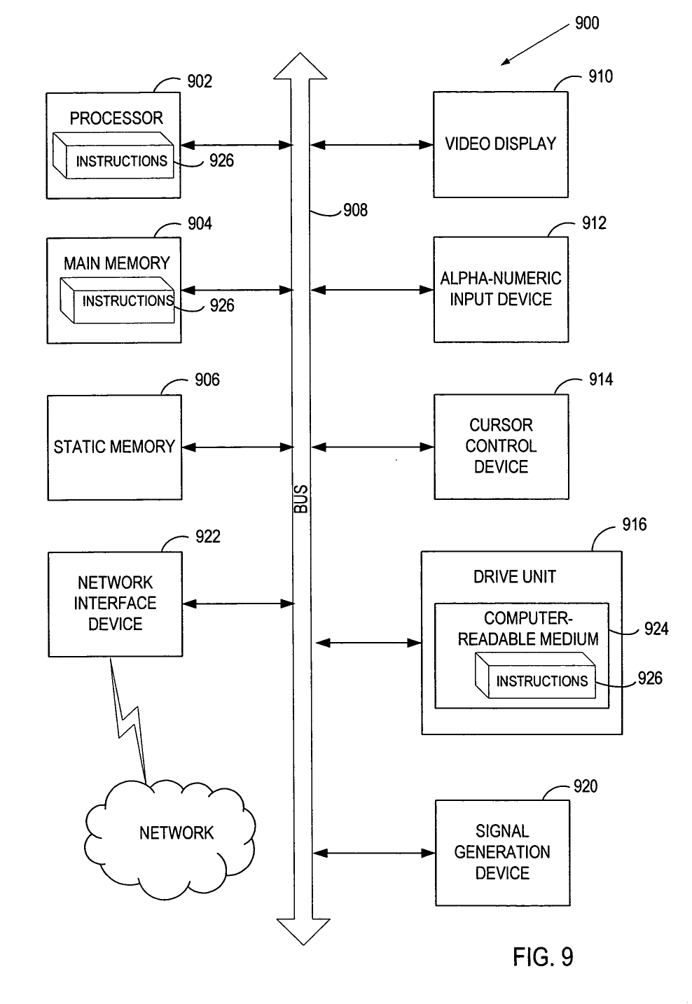

FIG. 9 is a block diagram of an exemplary computer system 900 (e.g., a server hosting the business process definition controller 100 of FIG. 1) that may be used to perform one or more of the operations described herein. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 900 includes a processor 902, a main memory 904 and a static memory 906, which communicate with each other via a bus 908. The computer system 900 may further include a video display unit 910 (e.g., a liquid crystal display (LCD), a cathode ray tube (CRT), or a video projector). The computer system 900 also includes an alpha-numeric input device 912 (e.g., a keyboard), a cursor control device 914 (e.g., a mouse), a disc drive unit 916, a signal generation device 920 (e.g., a speaker) and a network interface device 922.

The disc drive unit 916 includes a computer-readable medium 924 on which is stored a set of instructions (i.e., software) 926 embodying any one, or all, of the methodologies described above. The software 926 is also shown to reside, completely or at least partially, within the main memory 904 and/or within the processor 902. The software 926 may further be transmitted or received via the network interface device 922. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to include, but not be limited to, solid-state memories, optical and magnetic discs, and carrier wave signals.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A computerized method comprising:
enabling a plurality of user devices coupled via a local network to share media content stored on at least one disc changer, at least a portion of the media content having a copyright protection; and
maintaining the copyright protection of the media content shared by the plurality of user devices.

2. The method of claim 1 wherein:
the local network is a home network;
the plurality of user devices comprises consumer electronic devices; and
the media content comprises at least one of DVD content, digital photograph content, video content, television recording content, or audio content.

3. The method of claim 1 wherein the disc changer is a SCSI device directly attached to one of the plurality of user devices.

4. The method of claim 3 further comprising:
providing data identifying discs available on the disc changer to the plurality of user devices; and
receiving user requests pertaining to specific discs from the plurality of user devices.

5. The method of claim 4 wherein:
each user request pertaining to a specific disc is received as an iSCSI command; and
the method further comprises translating each user request into a SCSI command, and sending the SCSI command to the disc changer, the SCSI command causing the disc changer to load the specific disc into a drive of the disc changer.

6. The method of claim 5 further comprising:
receiving media content of the specific disc from the disc changer; and
sending the media content to a corresponding user device.

7. A computerized method comprising:
receiving, at a user device, media content stored on a remote disc changer coupled to the user device via a local network, at least a portion of the media content having a copyright protection; and
presenting the media content on the user device without violating the copyright protection.

8. The method of claim 7 wherein the disc changer is a SCSI device directly attached to a server coupled to the user device via the network.

9. The method of claim 8 further comprising:
sending a request for data identifying discs available on the disc changer to the server;
receiving the identifying data from the server;
presenting, based on the identifying data, a list of disks available on the remote disc changer to a user;
sending a request pertaining to a disc selected by the user from the list to the server;
receiving media content of the selected disc; and
presenting the media content to the user.

10. The method of claim 9 wherein:
the client device has a local disc changer directly attached thereto; and
the remote disc changer is directly attached to a second user device.

11. The method of claim 10 further comprising:
sending an iSCSI command to the second user device, the iSCSI command requesting data identifying discs available on the remote disc changer;
receiving data identifying discs available on the remote disc changer from the second user device;
compiling, based on the identifying data, a list of discs available on both local disc changer and remote disc changer; and
presenting the compiled list to the user.

12. The method of claim 11 further comprising:
receiving a user selection of one of the discs;
determining that the selected disc is stored in the remote disc changer;
sending a request pertaining to the selected disc to the second user device;
receiving media content of the selected disc; and
presenting the media content to the user.

13. A system comprising:
at least one disc changer to store media content, at least a portion of the media content having a copyright protection; and
a plurality of user devices, coupled to the at least one disc changer, to share the media content stored in the disc changer without violating the copyright protection of the media content.

14. The system of claim 13 wherein one of the plurality of user devices is coupled to the disc changer via an IEEE 1394 interface.

15. The system of claim 14 wherein the server is to provide data identifying discs available on the disc changer to the plurality of user devices, to receive user requests pertaining to specific discs from the plurality of user devices, and to cause the disc changer to load the specific discs into one or more disc changer drives.

16. The system of 15 wherein the plurality of user devices is to present, based on the identifying data, a list of discs to users, to send requests pertaining to discs selected by the users from the list to the server, to receive media content of selected discs from the server, and to present the media content to the users.

17. The system of claim 13 wherein the at least one disc changer comprises a first disc changer directly attached to a first one of the plurality of user devices, and a second disc changer directly attached to a second one of the plurality of user devices.

18. The system of claim 17 wherein the second user device is to provide data identifying disc available on the second disc changer to the first user device, and to receive an iSCSI command from the first user device, the iSCSI command identifying one of the discs available on the second disc changer.

19. The system of claim 18 wherein the second user device is further to send a SCSI command to the second disc changer, the SCSI command causing the second disc changer to load the identified disc into a disc changer drive.

20. The system of claim 19 wherein the first user device is to receive data identifying discs available on the second disc changer from the target device, to present, based on the identifying data, a combined list of discs available on both first and second disc changers to the user, to send a request pertaining to one of the discs selected by the user to the second user device using an iSCSI command, and to receive content of the selected disc.

21. A computer-readable medium having executable instructions to cause a computer system to perform a method comprising:
enabling a plurality of user devices coupled via a local network to share media content stored in at least one disc changer, at least a portion of the media content having a copyright protection; and
maintaining the copyright protection of the media content shared by the plurality of user devices.
